(19) United States
(12) Patent Application Publication
(10) Pub. No.: US 2024/0286966 A1
(43) Pub. Date: Aug. 29, 2024

(54) TITANIUM DIBORIDE PRODUCTS WITH DIRECTING FEATURES

(71) Applicant: ALCOA USA CORP., Pittsburgh, PA (US)

(72) Inventors: Xinghua Liu, Murrysville, PA (US); Benjamin D. Mosser, Pittsburgh, PA (US)

(21) Appl. No.: 18/657,321

(22) Filed: May 7, 2024

Related U.S. Application Data
(63) Continuation of application No. PCT/US2022/049159, filed on Nov. 7, 2022.
(60) Provisional application No. 63/276,892, filed on Nov. 8, 2021.

(51) Int. Cl. C04B 41/88; C04B 35/58; C04B 35/64; C25C 7/02

(52) U.S. Cl. CPC C04B 41/88; C04B 35/58071; C04B 35/64; C25C 7/02; C04B 2235/3813; C04B 2235/945

(57) ABSTRACT

The application is directed to products and methods related to a TiB₂ substrate with a directing feature, wherein the directing feature is configured to direct TiB₂ wettable material in a predetermined direction. In some embodiments, the TiB₂ substrate is at least partially covered with solid aluminum metal.

### CROSS-REFERENCE TO RELATED APPLICATION

This application is a continuation of International Patent Application No. PCT/US2022/049159, entitled “Methods and Systems of TiB₂ Products with Directing Features,” filed Nov. 7, 2022, which claims the benefit of U.S. Provisional Patent Application No. 63/276,892, entitled “Methods and Systems of TiB₂ Products with Infiltrated Solid Aluminum,” filed Nov. 8, 2021. Each of the above-identified patent applications is hereby incorporated by reference in its entirety.

### BACKGROUND

Aluminum has been traditionally made from alumina (Al₂O₃) that has been originated from bauxite ore. The conversion of alumina (Al₂O₃) to aluminum has been typically carried out via a smelting method that entails dissolving the alumina (Al₂O₃) in cryolite, a molten solvent, and then passing an electric current through the mixture, causing carbon from a carbon anode to attach to the oxygen component in the dissolved alumina (Al₂O₃), yielding aluminum and carbon dioxide as a by-product. Various efforts have been made to purify aluminum including the “Hoopes process” (see U.S. Pat. No. 1,534,315) as well as those methods described in commonly owned international patent application WO2016/130823.

### SUMMARY OF THE DISCLOSURE

Broadly, the present disclosure relates to methods and products involving a titanium diboride (TiB₂) substrate or a structure directing a TiB₂ wettable material in a predetermined direction using a directing feature. In some embodiments, the TiB₂ substrate structure can be covered with a solid aluminum metal before contacting the TiB₂ wettable material. When the TiB₂ wettable material contacts the TiB₂ substrate, the directing feature directs the TiB₂ wettable material in a predetermined direction. The directing feature can take many shapes and sizes. In some embodiments, the directing feature can be slots, grooves, pores, or combinations thereof. The TiB₂ substrate with the at least one directing feature can be used in a variety of applications including moving fluid in a product. In some embodiments, the TiB₂ wettable material may be any suitable metal for transfer via the TiB₂ substrates. In some embodiments, the TiB₂ wettable material is aluminum, such as aluminum alloy, metallic aluminum, and combinations thereof.

In one aspect, the present disclosure includes a product with a TiB₂ substrate that includes a directing feature, wherein the directing feature is configured to direct TiB₂ wettable material in a predetermined direction. In some embodiments, the TiB₂ wettable material includes aluminum. In some embodiments, the aluminum is selected from the group consisting of an aluminum alloy, metallic aluminum, and combinations thereof. In some embodiments, a surface of the TiB₂ substrate is at least partially covered in solid aluminum metal. In some embodiments, the directing feature is selected from the group consisting of slots, grooves, pores, and combinations thereof on the structure, e.g., the TiB₂ substrate. In some embodiments, the TiB₂ substrate has a solid geometric form. In some embodiments, the solid geometric form has at least one three-dimensional form of rectangle-shaped, square-shaped, triangle-shaped, oval-shaped, or oblong-shaped, among others. In some embodiments, the TiB₂ substrate has a non-symmetrical form. In some embodiments, the TiB₂ substrate is in the form of a plate.

In some embodiments, the TiB₂ substrate is configured for use in an aluminum purification cell. In some embodiments, the TiB₂ substrate is configured for use in an aluminum electrolysis cell. In some embodiments, the directing feature directs the TiB₂ wettable material via capillary action. In some embodiments, the directing feature includes pores. In some embodiments, the directing feature includes a porosity of the TiB₂ substrate. In some embodiments, the porosity ranges from about 1 to about 200 pores per inch (PPI). In some embodiments, the porosity is at least about 5 pores per inch (PPI), or at least about 10 pores per inch (PPI), or at least about 15 pores per inch (PPI), or at least about 20 pores per inch (PPI). In some embodiments, the porosity is not greater than about 175 pores per inch (PPI), or not greater than about 150 pores per inch (PPI), or not greater than about 125 pores per inch (PPI), or not greater than about 100 pores per inch (PPI), or not greater than about 80 pores per inch (PPI), or not greater than about 60 pores per inch (PPI), or not greater than about 50 pores per inch (PPI).

In some embodiments, the directing feature includes at least one slot that is open or closed, wherein the at least one slot extends through a thickness of the TiB₂ substrate. In some embodiments, dimensions of the at least one slot are predetermined. In some embodiments, the TiB₂ substrate includes a first prong and a second prong, and wherein the directing feature includes a slot defined between an inner surface of the first prong and an inner surface of the second prong. In some embodiments, the slot extends an entire length (l) of the first prong and an entire length (l) of the second prong. In some embodiments, the entire length (l) of the first prong and the entire length (l) of the second prong range from about 0.01 meters to about 1 meter. In some embodiments, a thickness (t) of the first prong and a thickness (t) of the second prong range from about 1 mm to about 20 mm. In some embodiments, the slot extends a distance (d) between the inner surface of the first prong and the inner surface of the second prong. In some embodiments, the distance (d) ranges from about 20 μm to about 20 mm. In some embodiments, a width (w) of the first prong and a width (w) of the second prong range from about 1 mm to about 20 mm.

As noted above, in some embodiments, the slot is fully closed. In some embodiments, when a slot is fully closed, the directing feature becomes a fully enclosed channel. In some embodiments, the at least one slot is partially closed, i.e., a partially closed slot. In some embodiments, a partially closed slot comprises a closed lateral width opening. When the at least one slot is partially closed, the lateral width opening of the at least one slot can be fully closed and extend continuously for a portion of a length of the slot. When the at least one slot is partially closed, the lateral width opening of the at least one slot can be partially closed for a whole length of the slot. When the at least one slot is partially closed, an amount of closure of the lateral width opening of the at least one slot can vary along the length of the slot.

As noted above, the substrate may include at least one channel. The channel can be any length, width, size, or shape. In some embodiments, the channel extends substantially parallel to a longitudinal axis of the substrate. In some embodiments, the channel extends at an angle to a longitudinal axis of the substrate. In some embodiments, more than one channel can converge to a single channel. In some embodiments, a single channel can split into more than one channel. A cross-section of the channel can be any shape or size. In some embodiments, the cross-section is substantially constant across a length of the channel. In some embodiments, the cross-section is variable across a length of the channel. In some embodiments, the cross-section can increase and/or decrease along a length of the channel.

In some embodiments, the directing feature includes a structure having at least one groove. In some embodiments, the at least one groove extends partially into the TiB₂ substrate. In some embodiments, the dimensions of the at least one groove are predetermined. In some embodiments, a size and/or a shape of the at least one groove are predetermined. In some embodiments, a width (w) of the at least one groove ranges from about 10 μm to about 20 mm. In some embodiments, a groove depth (gd) of the at least one groove ranges from about 1 mm to about 10 mm. In some embodiments, a length (l) of the at least one groove ranges from about 1 cm to about 1 m. In some embodiments, a thickness (t) of the TiB₂ substrate ranges from about 5 mm to about 30 mm. In some embodiments, the directing feature includes at least two grooves in the TiB₂ substrate. In some embodiments, an edge-to-edge distance (d) between the at least two grooves ranges from about 1 mm to about 20 mm.

In another aspect, the present disclosure includes a product having (a) a TiB₂ substrate including at least one directing feature and (b) solid aluminum metal at least partially covering surfaces of the TiB₂ substrate. In some embodiments, the solid aluminum metal is at least partially contained within the at least one directing feature. In some embodiments, the TiB₂ substrate includes a structure having a surface area, wherein a first portion of the surface area includes the at least one directing feature, and wherein a second portion of the surface area is absent of any directing feature. In some embodiments, the first portion of the surface area is at least partially covered by the solid aluminum metal. In some embodiments, the first portion of the surface area is at least 1% covered by the solid aluminum metal. In some embodiments, the second portion of the surface area is at least partially covered by the solid aluminum metal. In some embodiments, the second portion of the surface area is at least 1% covered by the solid aluminum metal. In some embodiments, the solid aluminum metal covering the second portion of the surface area is in the form of a film. In some embodiments, the film includes a thickness of from 1 μm to 500 μm. In some embodiments, the second portion of the surface area is absent of the solid aluminum metal.

In some embodiments, at least one directing feature includes a void volume, and wherein at least 1% of the void volume contains the solid aluminum metal. In some embodiments, the at least one directing feature is a structure having a slot, and wherein the solid aluminum metal is at least partially contained within the slot. In some embodiments, the at least one slot includes a slot volume, and wherein the solid aluminum metal occupies at least 1% of the slot volume. In some embodiments, the at least one directing feature is a groove, and wherein the solid aluminum metal is at least partially contained within the groove. In some embodiments, the at least one groove includes a groove volume, and wherein the solid aluminum metal occupies at least 1% of the groove volume. In some embodiments, the directing feature is in or on the substrate (e.g., the TiB₂ substrate or the ceramic substrate).

In another aspect, the present disclosure includes a product with (a) a web of TiB₂ and (b) solid aluminum metal at least partially covering surfaces of the web of TiB₂. In some embodiments, the web of TiB₂ defines a porosity of the web of TiB₂. In some embodiments, the solid aluminum metal includes porosity. In some embodiments, the porosity of the web of TiB₂ defines a porous volume of the TiB₂, and wherein the solid aluminum metal occupies at least 1% of the porous volume.

In another aspect, the present disclosure includes a method including producing a TiB₂ product with at least one directing feature and directing a TiB₂ wettable material in a predetermined direction via the at least one directing feature. In some embodiments, the producing step includes creating the TiB₂ product having a plurality of pores. In some embodiments, the producing step includes creating a geometric feature. In some embodiments, the producing step includes machining the TiB₂ product or a TiB₂ product precursor to create the at least one directing feature. In some embodiments, the producing step includes extruding a TiB₂ feedstock into a TiB₂ product precursor wherein the TiB₂ product precursor includes the at least on directing feature therein. In some embodiments, the TiB₂ product precursor is a green TiB₂ material. In some embodiments, the method includes exposing the green TiB₂ material to an elevated temperature, thereby creating the TiB₂ product. In some embodiments, the at least one directing feature in the TiB₂ substrate may include grooves, slots, channels, or combinations thereof.

In another aspect, the present disclosure includes an aluminum purification cell or an aluminum electrolysis cell having any of the TiB₂ substrates described herein. In some embodiments, at least one of the TiB₂ substrates is an electrode. In some embodiments, at least one of the TiB₂ substrates is a directing apparatus, wherein the directing apparatus is configured to direct liquid aluminum metal (e.g., molten aluminum metal) in a predetermined direction in an absence of an applied electrical current.

Although the present disclosure generally refers to TiB₂ substrates, other ceramic and/or cermet substrates having directing features may be used. Any ceramic and/or cermet substrate having a directing feature can be used with any wettable metal. In some embodiments, any wettable metal can be any suitable metal for transfer via the ceramic and/or cermet substrates. In some embodiments, the suitable metal may be aluminum, such as aluminum alloy, metallic aluminum, and combinations thereof. In some embodiments, the suitable metal may be copper, such as a copper alloy, metallic copper, and combinations thereof. In some embodiments, the wettable material consists essentially of aluminum, magnesium, copper, and combinations thereof. In some embodiments, the wettable material is predominantly aluminum. In one aspect, the present disclosure relates to a product with a ceramic substrate or a cermet substrate having a directing feature, wherein the directing feature is configured to direct ceramic wettable material or cermet wettable material in a predetermined direction. In some embodiments, the substrate is a ceramic substrate. In some embodiments, the ceramic substrate is one of a TiB₂ substrate, a ZrB₂ substrate, or a HfB₂ substrate. In some embodiments, the ceramic wettable material is aluminum, such as aluminum alloy, metallic aluminum, and combinations thereof.

While the above disclosures have been made relative to TiB₂ and aluminum, the apparatus, systems, and methods described herein are applicable to other ceramic and/or cermet materials other than TiB₂. For instance, the disclosures herein may be equally applicable to other metal borides (e.g., metal diborides) having metal wetting capabilities, such as ZrB₂ and HfB₂, just to name two, both of which are aluminum wettable materials.

In some embodiments, the substrate can be a carbon-based (carbonaceous) material. In some embodiments, the carbon-based material can be an inorganic, carbon-based material. Suitable carbon-based materials may include, for instance, amorphous and crystalline forms of carbon. In some embodiments, a carbon-based material comprises graphite. In some embodiments, the substrate comprises a pre-baked carbon electrode material. Carbon-based substrates may include a plated material to facilitate wetting of the suitable metal, e.g., of the aluminum.

In some embodiments, the substrate can be a non-carbonaceous material. Non-carbonaceous materials are any materials that are not carbon-based. Non-carbonaceous materials include, for instance, ceramic materials and cermet materials. In some embodiments, the substrate can be ceramic or cermet.

Ceramic materials include inorganic, non-metallic materials. Inorganic, non-metallic materials can include boride, oxide, nitride, or carbide materials. In some embodiments, ceramic materials include titanium. In some embodiments, ceramic materials include metal borides (e.g., metal diborides). In some embodiments, metal diboride materials include TiB₂, ZrB₂, HfB₂, or SrB₂.

Cermet materials are a material of ceramic and metal materials. Cermet materials can include a ceramic matrix bonded by a metallic binder. In some embodiments, the cermet material includes copper (Cu), nickel (Ni), chromium (Cr), tungsten (W), molybdenum (Mo), iron (Fe), cobalt (Co), or an alloy or combinations thereof. In some embodiments, cermet materials include nickel-titanium carbide or nickel-titanium diboride.

In some embodiments, the substrate comprises, consists essentially of, or consists of the stated material. In one embodiment, the substrate consists essentially of or consists of a ceramic. In one embodiment, the substrate consists essentially of or consists of a cermet. In one embodiment, the substrate consists essentially of or consists of a carbon-based material.

In some embodiments, the substrate is a plated material that facilitates wetting. In some embodiments, the plated material is a ceramic and/or a cermet such as any of the ceramic or cermet materials described herein. In some embodiments, the substrate is carbon-based material plated with a ceramic, e.g., TiB₂.

### BRIEF DESCRIPTION OF THE DRAWINGS

FIG. 1A illustrates one embodiment of a method for directing a TiB₂ wettable material in a predetermined direction using a directing feature.

FIG. 1B illustrates another embodiment of a method for directing a TiB₂ wettable material in a predetermined direction using a directing feature.

FIG. 2A is a perspective view of an embodiment of a product with a TiB₂ substrate having a plurality of slots as directing features.

FIG. 2B is a first side view of the embodiment shown in FIG. 2A.

FIG. 2C is an enlarged partial section view of the embodiment shown in FIG. 2A indicated by the circle of dashed lines in FIG. 2A.

FIG. 3A is a front view of an embodiment of a product with a TiB₂ substrate having a slot as a directing feature.

FIG. 3B is a section view of a cross-section taken along the dashed line 3B shown in FIG. 3A.

FIG. 3C is a first side view of the embodiment shown in FIG. 3A.

FIG. 4A is a front view of an embodiment of a product with a TiB₂ substrate having a plurality of grooves as directing features.

FIG. 4B is a first side view of the embodiment shown in FIG. 4A.

FIG. 4C is an enlarged partial section view of the embodiment shown in FIG. 4A indicated by the circle of dashed lines in FIG. 4A.

FIG. 4D is an alternative configuration of the plurality of grooves of the embodiment shown in FIG. 4C.

FIG. 5A is a side view of another embodiment of a product with a TiB₂ substrate having a plurality of pores as directing features.

FIG. 5B is a close-up view of a portion of the embodiment shown in FIG. 5A indicated by dashed lines in FIG. 5A.

FIG. 6A is a perspective view of an embodiment of a product with a TiB₂ substrate having a plurality of slots as directing features and a solid aluminum metal covering the TiB₂ substrate.

FIG. 6B is a first side view of a cross-section taken along the arrows 6B shown in FIG. 6A.

FIG. 6C is an enlarged partial section view of the embodiment shown in FIG. 6A indicated by the circle of dashed lines in FIG. 6A.

FIG. 6D is a cross-sectional side view of an embodiment of a product with a TiB₂ substrate having a plurality of slots as directing features and a solid aluminum metal covering an upper portion of the TiB₂ substrate.

FIG. 6E is a partial cross-section taken along the dashed line 6E shown in FIG. 6D where only one of the slots of the plurality of slots is shown. The cross-section is along the upper portion of the TiB₂ substrate where there is solid aluminum metal.

FIG. 6F is a partial cross-section taken along the dashed line 6F shown in FIG. 6D where only one of the slots of the plurality of slots is shown. The cross-section is along the lower portion of the TiB₂ substrate where there is no solid aluminum metal.

FIG. 6G is a cross-sectional side view of an embodiment of a TiB₂ substrate having a plurality of slots as directing features and a solid aluminum metal covering half of the TiB₂ substrate, the front portion.

FIG. 6H is a partial cross-section taken along the dashed line 6H as shown in FIG. 6G where only one of the slots of the plurality of slots is shown.

FIG. 6I is a side view of an embodiment of a TiB₂ substrate having a plurality of slots as directing features and a solid aluminum metal in the plurality of slots.

FIG. 6J is a partial cross-section taken along the dashed line 6J as shown in FIG. 6I where only one of the slots of the plurality of slots is shown.

FIG. 6K is a front view of an embodiment of a TiB₂ substrate having a plurality of slots as directing features and a solid aluminum metal covering some or none of the slots.

FIG. 6L is a first side view of the embodiment shown in FIG. 6K.

FIG. 6M is a front view of an embodiment of a TiB₂ substrate with a surface area having a first portion of the surface area with a plurality of slots as directing features and a second portion of the surface area being absent of any directing feature.

FIG. 6N is a first side view of the embodiment shown in FIG. 6M with the second portion of the surface area being absent of any directing feature.

FIG. 7A is a front view of an embodiment of a product with a TiB₂ substrate having a slot as a directing feature and a solid aluminum metal covering the TiB₂ substrate.

FIG. 7B is a cross-section taken along the dashed line 7B shown in FIG. 7A.

FIG. 7C is a first side view of a cross-section taken along the line 7C shown in FIG. 7A.

FIG. 7D is a front view of an embodiment of a product of a TiB₂ substrate having a slot as a directing feature and a solid aluminum metal covering a portion of the slot.

FIG. 7E is a cross-section taken along the dashed line 7E shown in FIG. 7D.

FIG. 7F is a first side view of the embodiment shown in FIG. 7F.

FIG. 8A is a front view of an embodiment of a product with a TiB₂ substrate having a plurality of grooves as directing features and a solid aluminum metal covering the TiB₂ substrate.

FIG. 8B is a first side view of a cross-section taken along line 8B shown in FIG. 8A.

FIG. 8C is an enlarged partial section view of the embodiment shown in FIG. 8A indicated by the circle of dashed lines in FIG. 8A.

FIG. 8D is a rear view of an embodiment of a product of a TiB₂ substrate having a plurality of grooves as directing features and a solid aluminum metal covering the front half of the TiB₂ substrate.

FIG. 8E is a first side view of a cross-section taken along line 8E shown in FIG. 8D.

FIG. 8F is an enlarged partial section view of the embodiment shown in FIG. 8D indicated by the circle of dashed lines in FIG. 8F.

FIG. 9 is a close-up view of a portion of an embodiment with pores and solid aluminum metal, in accordance with some embodiments.

FIG. 10 is a frontal view of a TiB₂ foam sintered end product that was used in lab-scale testing.

FIG. 11 is a frontal view of four TiB₂ foam samples that were used in lab-scale testing, the samples having porosities of about 10, 20, 30, and 45 pores per inch (“PPI”).

FIG. 12 is a schematic cut-away side view of three crucibles that were used in lab-scale testing, each including four TiB₂ foam samples submerged (partially or completely) in molten aluminum for 48 hours.

FIG. 13A is a frontal view of a TiB₂ foam sample from a crucible that was used in lab-scale testing after it was fully submerged for about 48 hours in molten aluminum.

FIG. 13B is a frontal view of a TiB₂ foam sample from a crucible that was used in lab-scale testing after it was partially submerged for about 48 hours in molten aluminum.

### DETAILED DESCRIPTION

The present disclosure will be further explained with reference to the attached drawings, wherein like structures are referred to by like numerals throughout the several views. The figures constitute a part of this specification and include illustrative embodiments of the present disclosure and illustrate various objects and features thereof. Further, the figures are not necessarily to scale, some features may be exaggerated to show details of particular components. In addition, any measurements, specifications and the like shown in the figures are intended to be illustrative, and not restrictive. Therefore, specific structural and functional details disclosed herein are not to be interpreted as limiting, but merely as a representative basis for teaching one skilled in the art to variously employ the present disclosure.

Among those benefits and improvements that have been disclosed, other objects and advantages of the present disclosure will become apparent from the following description taken in conjunction with the accompanying figures. Detailed embodiments of the present disclosure are disclosed herein; however, it is to be understood that the disclosed embodiments are merely illustrative of the present disclosure that may be embodied in various forms. In addition, each of the examples given in connection with the various embodiments of the invention which are intended to be illustrative, and not restrictive.

Throughout the specification and claims, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.

As used herein, “aluminum-wettable” means having a contact angle with molten aluminum of not greater than 90 degrees.

As used herein, “TiB₂ wettable material” means having a contact angle with TiB₂ of not greater than 90 degrees.

As used herein, “slot” means a geometric feature that extends through a thickness of a TiB₂ substrate.

As used herein, “groove” means a geometric feature that extends partially through, but not all the way through, through a thickness of a TiB₂ substrate.

As used herein, “geometric feature” means a predetermined shape created in a TiB₂ substrate. Examples include slots and grooves of any shape or size.

As used herein, “TiB₂ substrate” means a substrate made of TiB₂ that is capable of including at least one directing feature. Examples of TiB₂ substrates include blocks, plates, rod, wires, and wools, among others, made of TiB₂. In one embodiment, a TiB₂ substrate consists essentially of TiB₂.

As used herein, “aluminum covered TiB₂ substrate” means a TiB₂ substrate at least partially covered by aluminum metal, wherein the aluminum metal is metallic aluminum and/or an aluminum alloy. In one embodiment, the aluminum metal is at least partially contained in at least one directing feature of a TiB₂ substrate. In one embodiment, the aluminum metal at least partially covers outer surfaces of a TiB₂ substrate. In one embodiment, the aluminum metal covers at least 5% of the surface area of a TiB₂ substrate. In one embodiment, the aluminum metal covers at least 10% of the surface area of a TiB₂ substrate. In one embodiment, the aluminum metal covers at least 15% of the surface area of a TiB₂ substrate. In one embodiment, the aluminum metal covers at least 20% of the surface area of a TiB₂ substrate. In one embodiment, the aluminum metal covers at least 25% of the surface area of a TiB₂ substrate. In one embodiment, the aluminum metal covers at least 30% of the surface area of a TiB₂ substrate. In one embodiment, the aluminum metal covers at least 35% of the surface area of a TiB₂ substrate. In one embodiment, the aluminum metal covers at least 40% of the surface area of a TiB₂ substrate. In one embodiment, the aluminum metal covers at least 45% of the surface area of a TiB₂ substrate. In one embodiment, the aluminum metal covers at least 50% of the surface area of a TiB₂ substrate. In one embodiment, the aluminum metal covers at least 55% of the surface area of a TiB₂ substrate. In one embodiment, the aluminum metal covers at least 60% of the surface area of a TiB₂ substrate. In one embodiment, the aluminum metal covers at least 65% of the surface area of a TiB₂ substrate. In one embodiment, the aluminum metal covers at least 70% of the surface area of a TiB₂ substrate. In one embodiment, the aluminum metal covers at least 75% of the surface area of a TiB₂ substrate. In one embodiment, the aluminum metal covers at least 80% of the surface area of a TiB₂ substrate. In one embodiment, the aluminum metal covers at least 85% of the surface area of a TiB₂ substrate. In one embodiment, the aluminum metal covers at least 90% of the surface area of a TiB₂ substrate. In one embodiment, the aluminum metal covers at least 91% of the surface area of a TiB₂ substrate. In one embodiment, the aluminum metal covers at least 92% of the surface area of a TiB₂ substrate. In one embodiment, the aluminum metal covers at least 93% of the surface area of a TiB₂ substrate. In one embodiment, the aluminum metal covers at least 94% of the surface area of a TiB₂ substrate. In one embodiment, the aluminum metal covers at least 95% of the surface area of a TiB₂ substrate. In one embodiment, the aluminum metal covers at least 96% of the surface area of a TiB₂ substrate. In one embodiment, the aluminum metal covers at least 97% of the surface area of a TiB₂ substrate. In one embodiment, the aluminum metal covers at least 98% of the surface area of a TiB₂ substrate. In one embodiment, the aluminum metal covers at least 99% of the surface area of a TiB₂ substrate. In one embodiment, the aluminum metal covers at least 100% of the surface area of a TiB₂ substrate.

As used herein, “plated material” and the like means a film, coating, or other thin covering in contact with at least a portion of an outer surface of a substrate, and irrespective how the plated material was produced on the substrate, i.e., plating includes all manners of applying a film, coating, or thin covering to a substrate.

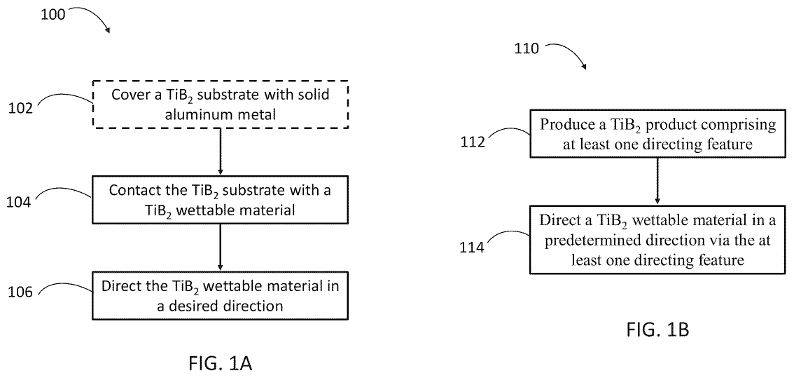

FIG. 1A illustrates one embodiment of a method 100 for directing a TiB₂ wettable material in a predetermined direction using a directing feature. Step 102 is an optional step as indicated by the dashed lines of the box in FIG. 1A. The step 102 includes covering a TiB₂ substrate with solid aluminum metal. Varying amount of the TiB₂ substrate can be covered with solid aluminum metal. In some embodiments, all of the TiB₂ substrate can be covered. Some portions of the TiB₂ substrate can be covered with solid aluminum metal while other portions of the TiB₂ substrate are absent solid aluminum. The solid aluminum metal coverage can vary depending on the application of the TiB₂ substrate. Step 104 includes contacting the TiB₂ substrate with a TiB₂ wettable material. Step 106 includes directing the TiB₂ wettable material in a desired direction.

FIG. 1B illustrates another embodiment of a method 110 for directing a TiB₂ wettable material in a predetermined direction using a directing feature. The producing step 112 includes producing a TiB₂ product with at least one directing feature. The producing step 112 can include creating a TiB₂ product structure having a plurality of pores. The producing step 112 can include creating a geometric feature. The producing step 112 can include machining a TiB₂ product or a TiB₂ product precursor structure to create at least one directing feature. The directing feature found in or on the product or product precursor structure can be slots, grooves, pores, and combinations thereof. The directing features can include a void volume. In some embodiments, at least 1% of the void volume contains the solid aluminum metal. The directing feature can direct the TiB₂ wettable material via capillary action.

The producing step 112 can include extruding a TiB₂ feedstock into a TiB₂ product precursor wherein the TiB₂ product precursor includes at least on directing feature therein. In some embodiments, the TiB₂ product precursor is a green TiB₂ material. The producing step 112 can include exposing the green TiB₂ material to an elevated temperature, thereby creating the TiB₂ product. The directing step 114 includes directing a TiB₂ wettable material in a predetermined direction via the at least one directing feature.

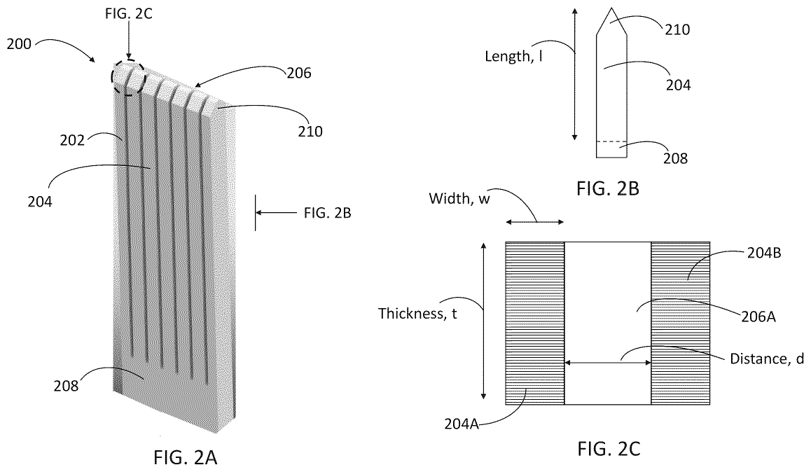

FIG. 2A is a perspective view of an embodiment of a product 200 with a TiB₂ substrate 202 having a plurality of slots 206 as directing features. The slots 206 are defined between prongs 204. The TiB₂ substrate 202 also includes a base 208 and a tip 210. The slots 206 are configured to direct TiB₂ wettable material in a predetermined direction. The TiB₂ wettable material can include aluminum, such as an aluminum alloy, metallic aluminum, and combinations thereof.

FIG. 2B is a first side view of the embodiment shown in FIG. 2A. FIG. 2B shows a side view of the product 200 showing the prongs 204. The prongs 204 include a length (l) that extends from the top of the base 208 to the end of the tip 210. The tip 210 can have any of a variety of geometries including a point, a rounded curvature, or a jagged edge, among others.

FIG. 2C is an enlarged partial section view of the embodiment shown in FIG. 2A indicated by the circle of dashed lines in FIG. 2A. The partial top view only shows two of the prongs 204. That is, FIG. 2C shows a first prong 204A and a second prong 204B defining a first slot 206A. The first slot 206A is defined by an inner surface of the first prong 204A and an inner surface of the second prong 204B.

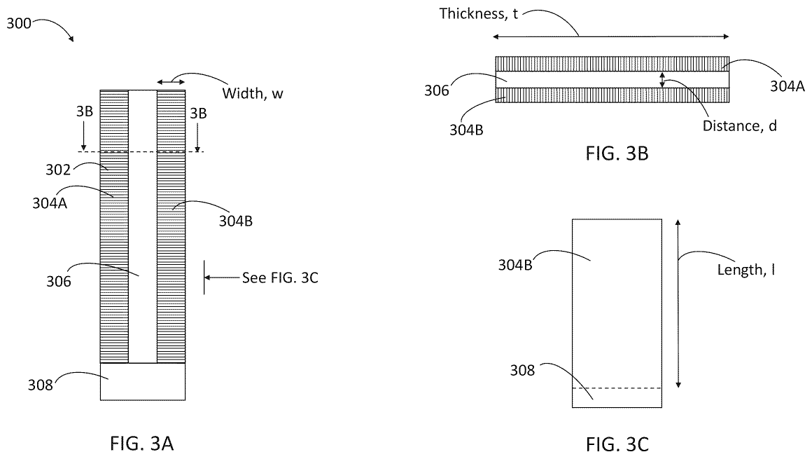

FIG. 3A is a front view of an embodiment of a product 300 with a TiB₂ substrate 302 having a slot 306 as a directing feature. The slot 306 is defined by a first prong 304A and a second prong 304B (collectively, prongs 304). The TiB₂ substrate 302 also includes a base 308 and a tip 310. The slots 306 are configured to direct TiB₂ wettable material in a predetermined direction. A width (w) of one of the prongs is also shown.

FIG. 3B is a section view of a cross-section taken along the dashed line 3B shown in FIG. 3A. FIG. 3B shows a thickness (t) of the prongs 304 and a distance (d) the slot 306 extends between the inner surface of the first prong 304A and the inner surface of the second prong 304B. FIG. 3C is a first side view of the embodiment (e.g., the product 300) shown in FIG. 3A. FIG. 3C displays a length (l) of the prongs 304.

FIGS. 2A-2C and FIGS. 3A-3C will be described together, as they are similar. The embodiment of FIGS. 2A-2C differs from the embodiment of FIGS. 3A-3C in the number of prongs 204/304, the number of slots 206/306, and thickness (t) of the prongs 204/304.

The dimensions of the slots 206/306 are predetermined. In some embodiments, the slot 206A/306 extends an entire length (l) of the first prong 206A/306A and an entire length (l) of the second prong 206B/306B. The entire length (l) of the first prong 206A/306A and the entire length (l) of the second prong 204B/304B can range from about 0.01 meters to about 1 meter. A thickness (t) of the first prong 204A/304A and a thickness (t) of the second prong 204B/304B can range from about 1 mm to about 20 mm. The slot 206A/306 extends a distance (d) between the inner surface of the first prong 204A/304A and the inner surface of the second prong 204B/304B. In some embodiments, the distance (d) ranges from about 20 μm to about 20 mm. A width (w) of the prongs 204/304 (e.g., first prong 204A/304A and the second prong 204B/304B) can range from about 1 mm to about 20 mm.

The prongs 204/304 can vary in dimension from one another. The prongs 204/304 can vary in length (l), thickness (t), and width (w) from one another. Similarly, the distance (d) of the slot 206/306 can vary from one another. In some embodiments, in comparison to the second prong 204B/304B, the first prong 204A/304A can have a larger length (l) and width (w) and a smaller thickness (t).

The slots 206/306 extend through a thickness of the TiB₂ substrate 202/302. The number of slots can vary. In some embodiments, there can be one slot as shown in the examples of FIG. 3A, FIG. 3B, and FIG. 3C. There can also be two or more slots. The number of slots can vary depend on the intended application of the TiB₂ substrate 202/302. In the example shown in FIG. 2A, FIG. 2B, and FIG. 2C, there are six slots.

The TiB₂ substrate 202/302 can be at least partially covered in solid aluminum metal. The slots 206/306 are the directing feature for the TiB₂ substrate 202/302. Other directing features, such as grooves, pores, and combinations thereof, can be included with the TiB₂ substrate 202.

The TiB₂ substrate 202/302 can have any suitable structure, size, or shape depending on application. The TiB₂ substrate 202/302 can have a solid geometric form. The geometric form surface can include at least one of rectangle-shaped, square-shaped, triangle-shaped, oval-shaped, or oblong-shaped surfaces, among others. The TiB₂ substrate 202/302 can also be a non-symmetrical form. The TiB₂ substrate 202/302 can also be in the form of a plate. The TiB₂ substrate 202/302 can use the slots 206/306, the directing feature, to direct TiB₂ wettable material via capillary action.

The TiB₂ substrate 202/302 can be used in a variety of applications. In some embodiments, the TiB₂ substrate 202/302 can be configured for use in an aluminum purification cell or for use in an aluminum electrolysis cell. In an aluminum purification cell, the cathode is at the top of the cell, the anode is at the bottom of the cell, and the purified aluminum moves to the top of cell. One example of an aluminum purification cell can be found in commonly owned U.S. Pat. No. 10,407,786, entitled Systems and Methods for Purifying Aluminum, and filed on Feb. 11, 2016. In an aluminum electrolysis cell, the cathode is at the bottom of the cell, the anode is at the top of the cell, and the produced aluminum moves to the bottom of the cell. One example of an aluminum electrolysis cell can be found in commonly owned US Patent Publication No. 2017/0283968, entitled Apparatuses and Systems for Vertical Electrolysis Cells, and filed on Mar. 30, 2017.

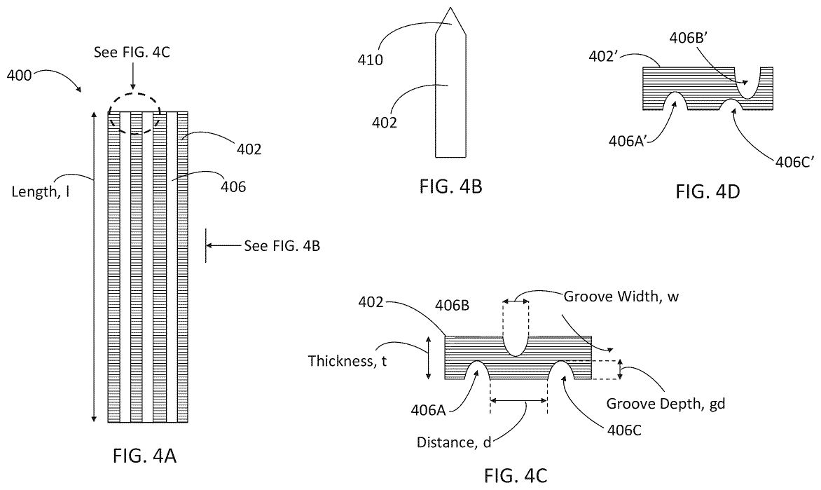

FIG. 4A is a front view of an embodiment of a product 400 with a TiB₂ substrate 402 having a plurality of grooves 406 as directing features. FIG. 4B is a first side of the embodiment shown in FIG. 4A. FIG. 4C is an enlarged partial section view of the embodiment shown in FIG. 4A indicated by the circle of dashed lines in FIG. 4A. FIG. 4D is an alternative configuration of the plurality of grooves of the embodiment as shown in FIG. 4C.

The product 400 is similar to the product 200/300. Differences are described herein. In some embodiments, the directing feature of the product 200/300 is slots 206/306; in contrast, the directing feature of the product 400 is at least one groove 406.

The grooves 406 extend partially into the TiB₂ substrate 402. The dimensions of the grooves 406 are predetermined. In some embodiments, a size and/or a shape of the grooves 406 are predetermined. A width (w) of the grooves 406 ranges from about 10 μm to about 20 mm. A groove depth (gd) of the grooves 406 ranges from about 1 mm to about 10 mm. A length (l) of the grooves 406 ranges from about 1 cm to about 1 m. A thickness (t) of the TiB₂ substrate 402 ranges from about 5 mm to about 30 mm. An edge-to-edge distance (d) between the grooves 406 ranges from about 1 mm to about 20 mm.

As shown in FIG. 4C, the directing feature includes at least two grooves 406 in the TiB₂ substrate 402. Specifically, the directing feature includes three grooves 406. FIG. 4C shows a first groove 406A, a second groove 406B, a third groove 406C (collectively, grooves 406).

The grooves 406 can be arranged in any pattern. The grooves 406 can also have the same dimensions as one another or have different dimensions from one another. The grooves 406 can also be located on the sides of the TiB₂ substrate 402, not only on the front side and back side as shown in FIG. 4C. FIG. 4D shows a first groove 406A′, a second groove 406B′, a third groove 406C′ (collectively, grooves 406′). FIG. 4D shows alternative dimensions and arrangement of the grooves 406′ as compared to the grooves 406 of FIG. 4C. FIG. 4C shows the grooves having the same dimensions as one another and arranged in a pattern where the grooves 406 are positioned in an alternating pattern between a front side and back side of the TiB₂ substrate 402. FIG. 4D shows that the grooves 406′ can have different dimensions. In some embodiments, the second groove 406B′ is the largest groove with a groove depth that extends further than halfway through the TiB₂ substrate 402. The third groove 406C′ is the smallest groove and extends less than halfway through the TiB₂ substrate 402′.

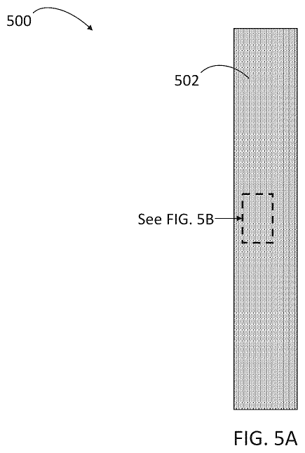

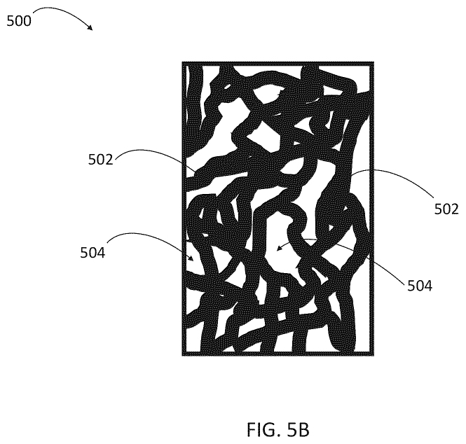

FIG. 5A is a side view of another embodiment of a product 500 with a TiB₂ substrate 502 having a plurality of pores as directing features. FIG. 5B is a close-up view of a portion of the embodiment shown in FIG. 5A indicated by dashed lines in FIG. 5A. As shown in FIG. 5A, the TiB₂ substrate is a web, e.g., a sponge-like structure, of TiB₂. The pores 504 are defined by the TiB₂ substrate 502, the web of TiB₂. The directing features of the product 500 can be a porosity of the TiB₂ substrate 502. The porosity of the TiB₂ substrate 502 can range from about 1 pore to about 200 pores per square inch (PPI). In some embodiments, the porosity is at least about 5 pores per inch (PPI), or at least about 10 pores per inch (PPI), or at least about 15 pores per inch (PPI), or at least about 20 pores per inch (PPI). In some embodiments, the porosity is not greater than about 175 pores per inch (PPI), or not greater than about 150 pores per inch (PPI), or not greater than about 125 pores per inch (PPI), or not greater than about 100 pores per inch (PPI), or not greater than about 80 pores per inch (PPI), or not greater than about 60 pores per inch (PPI), or not greater than about 50 pores per inch (PPI).

The porosity of the TiB₂ substrate 502 can have any suitable porous structure. The porosity of the TiB₂ substrate 502 can be an interconnected porous structure, wherein at least some of the pores are in fluid communication with one another and facilitate movement of the wettable material from a first location to a second location (e.g., from a first predetermined location to a second predetermined location). Accordingly, the interconnected porous structure may be considered an open pore structure. In some embodiments, the porosity of the TiB₂ substrate 502 has a random porous structure. In some embodiments, the porosity of the TiB₂ substrate 502 can be an oriented porous structure. In some embodiments, the porosity of the oriented porous structure of the TiB₂ substrate 502 can have a porosity gradient. In some embodiments, the porosity gradient of the oriented porous structure of the TiB₂ substrate 502 can change along a three-dimensional gradient (i.e., the porosity gradient can change along the X-axis, Y-axis, and Z-axis of the TiB₂ substrate 502). In some embodiments, the porosity gradient of the oriented porous structure of the TiB₂ substrate 502 increases or decreases toward the center of the TiB₂ substrate 502. In some embodiments, the porosity gradient of the oriented porous structure of the TiB₂ substrate 502 can increase and/or decrease through the TiB₂ substrate 502. For instance, the porosity gradient of the oriented porous structure of the TiB₂ substrate 502 can increase, decrease, and then increase from one end of the TiB₂ substrate 502 to another end of the TiB₂ substrate 502.

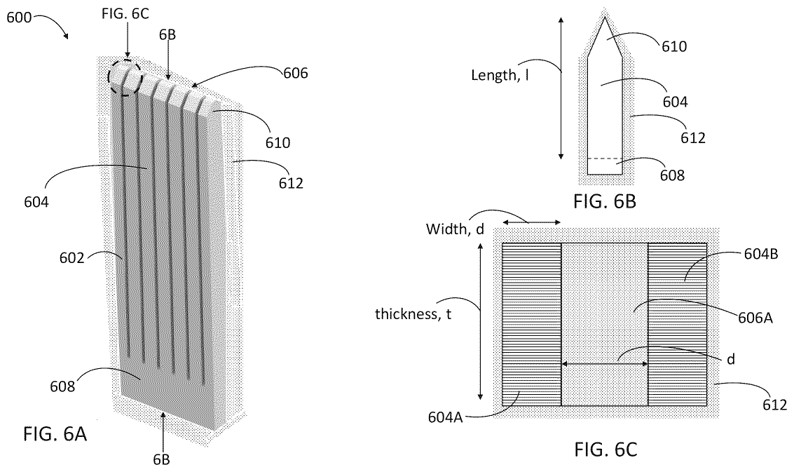

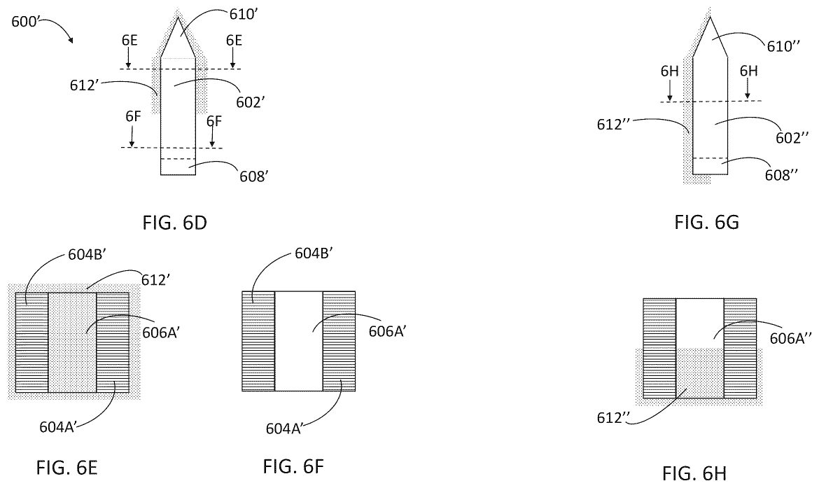

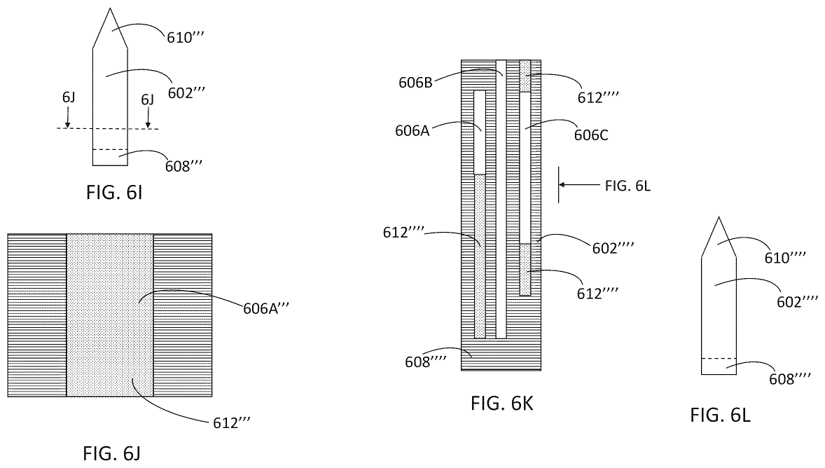

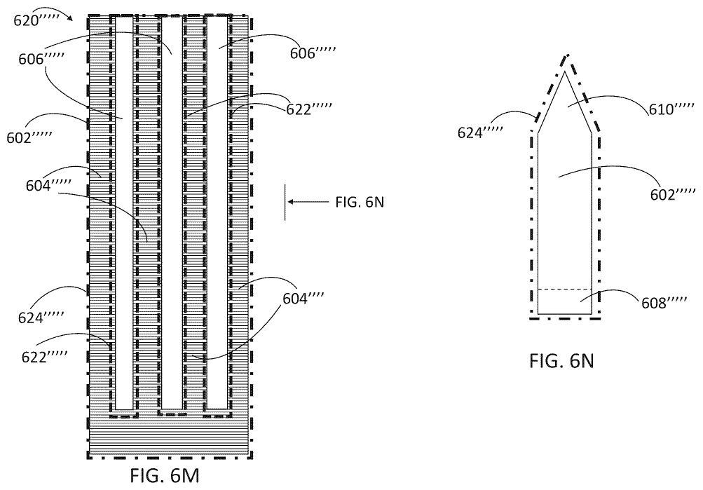

FIG. 6A is a perspective view of an embodiment of a product 600 with a TiB₂ substrate 602 having a plurality of slots 606 as directing features and a solid aluminum metal 612 covering the TiB₂ substrate 602. A portion of the solid aluminum metal 612 is shown around or transparent in FIG. 6A to reveal the surface structure of the substrate 602. The product 600 includes prongs 604, a base 608, and a tip 610. FIG. 6B is a first side view of a cross-section taken along the arrows 6B shown in FIG. 6A. FIG. 6C is an enlarged partial section view of the embodiment shown in FIG. 6A indicated by the circle of dashed lines in FIG. 6A. The embodiments shown in FIGS. 2A, 2B, and 2C is the same or similar as the embodiment of FIGS. 6A, 6B, and 6C except for the differences described herein. In some embodiments, the embodiment shown in FIGS. 6A, 6B, and 6C includes solid aluminum metal 612 covering the TiB₂ substrate structures shown in FIGS. 2A, 2B, and 2C (e.g., the TiB₂ substrate 202). For FIGS. 6A, 6B, and 6C, similar features of FIGS. 2A, 2B, and 2C will not be repeated. FIG. 6A and FIG. 6B show the solid aluminum metal 612 completely covering the TiB₂ substrate 602. FIG. 6C shows the solid aluminum metal 612 completely occupying the slot 606A between a first prong 604A and a second prong 604B.

In some embodiments, the solid aluminum metal 612 at least partially covers the surface of the TiB₂ substrate 602 and/or the solid aluminum metal 612 is at least partially contained within the slot 606. In some embodiments, the solid aluminum metal 612 covers at least 1% of the surface of the TiB₂ substrate 602. In some embodiments, the solid aluminum metal 612 covers at least 5% of the surface of the TiB₂ substrate 602. In some embodiments, the solid aluminum metal 612 covers at least 10% of the surface of the TiB₂ substrate 602. In some embodiments, the solid aluminum metal 612 covers at least 15% of the surface of the TiB₂ substrate 602. In some embodiments, the solid aluminum metal 612 covers at least 20% of the surface of the TiB₂ substrate 602. In some embodiments, the solid aluminum metal 612 covers at least 25% of the surface of the TiB₂ substrate 602. In some embodiments, the solid aluminum metal 612 covers at least 30% of the surface of the TiB₂ substrate 602. In some embodiments, the solid aluminum metal 612 covers at least 35% of the surface of the TiB₂ substrate 602. In some embodiments, the solid aluminum metal 612 covers at least 40% of the surface of the TiB₂ substrate 602. In some embodiments, the solid aluminum metal 612 covers at least 45% of the surface of the TiB₂ substrate 602. In some embodiments, the solid aluminum metal 612 covers at least 50% of the surface of the TiB₂ substrate 602. In some embodiments, the solid aluminum metal 612 covers at least 55% of the surface of the TiB₂ substrate 602. In some embodiments, the solid aluminum metal 612 covers at least 60% of the surface of the TiB₂ substrate 602. In some embodiments, the solid aluminum metal 612 covers at least 65% of the surface of the TiB₂ substrate 602. In some embodiments, the solid aluminum metal 612 covers at least 70% of the surface of the TiB₂ substrate 602. In some embodiments, the solid aluminum metal 612 covers at least 75% of the surface of the TiB₂ substrate 602. In some embodiments, the solid aluminum metal 612 covers at least 80% of the surface of the TiB₂ substrate 602. In some embodiments, the solid aluminum metal 612 covers at least 85% of the surface of the TiB₂ substrate 602. In some embodiments, the solid aluminum metal 612 covers at least 90% of the surface of the TiB₂ substrate 602. In some embodiments, the solid aluminum metal 612 covers at least 95% of the surface of the TiB₂ substrate 602. In some embodiments, the solid aluminum metal 612 covers at least 100% of the surface of the TiB₂ substrate 602.

In some embodiments, the solid aluminum metal 612 is at least partially contained within the slot 606. In some embodiments, where the slot 606 has a slot volume, the solid aluminum metal 612 occupies at least 1% of the slot volume. In some embodiments, the solid aluminum metal 612 occupies at least 5% of the slot volume. In some embodiments, the solid aluminum metal 612 occupies at least 10% of the slot volume. In some embodiments, the solid aluminum metal 612 occupies at least 15% of the slot volume. In some embodiments, the solid aluminum metal 612 occupies at least 20% of the slot volume. In some embodiments, the solid aluminum metal 612 occupies at least 25% of the slot volume. In some embodiments, the solid aluminum metal 612 occupies at least 30% of the slot volume. In some embodiments, the solid aluminum metal 612 occupies at least 35% of the slot volume. In some embodiments, the solid aluminum metal 612 occupies at least 40% of the slot volume. In some embodiments, the solid aluminum metal 612 occupies at least 45% of the slot volume. In some embodiments, the solid aluminum metal 612 occupies at least 50% of the slot volume. In some embodiments, the solid aluminum metal 612 occupies at least 55% of the slot volume. In some embodiments, the solid aluminum metal 612 occupies at least 60% of the slot volume. In some embodiments, the solid aluminum metal 612 occupies at least 65% of the slot volume. In some embodiments, the solid aluminum metal 612 occupies at least 70% of the slot volume. In some embodiments, the solid aluminum metal 612 occupies at least 75% of the slot volume. In some embodiments, the solid aluminum metal 612 occupies at least 80% of the slot volume. In some embodiments, the solid aluminum metal 612 occupies at least 85% of the slot volume. In some embodiments, the solid aluminum metal 612 occupies at least 90% of the slot volume. In some embodiments, the solid aluminum metal 612 occupies at least 95% of the slot volume. In some embodiments, the solid aluminum metal 612 occupies at least 100% of the slot volume.

Varying amounts of the solid aluminum metal 612 are shown occupying the slots 606 and the TiB₂ substrate 602 in the embodiments shown in FIGS. 6A-6N.

FIG. 6D is a cross-sectional side view of an embodiment of a product 600′ with a TiB₂ substrate 602′ having a plurality of slots 606A′ as directing features and a solid aluminum metal 612′ covering an upper portion of the TiB₂ substrate 602′. FIG. 6E is a partial cross-section taken along the dashed line 6E as shown in FIG. 6D where only one of the slots 606A′ of the plurality of slots 606A′ is shown. The cross-section is along the upper portion of the TiB₂ substrate 602′ where there is solid aluminum metal 612′. FIG. 6F is a partial cross-section taken along the dashed line 6F shown in FIG. 6D where only one of the slots 606A′ of the plurality of slots 606A′ is shown. The cross-section is along the lower portion of the TiB₂ substrate 602′ where there is no solid aluminum metal 612′.

FIG. 6G is a cross-sectional side view of an embodiment of a TiB₂ substrate 602″ having a plurality of slots 606A″ as directing features and a solid aluminum metal 612″ covering half of the TiB₂ substrate 602″, the front portion. The solid aluminum metal 612″ covers the front half of the base 608″ and the tip 610″. FIG. 6H is a partial cross-section taken along the dashed line 6H as shown in FIG. 6G where only one of the slots 606A″ of the plurality of slots 606A″ is shown. The solid aluminum metal 612″ covers the front half of the slot 606A″.

FIG. 6I is a side view of an embodiment of a TiB₂ substrate 602′″ with a base 608′″ and tip 610′″ having a plurality of slots 606A′″ as directing features and a solid aluminum metal 612′″ in the plurality of slots 606A′″. FIG. 6J is a partial cross-section taken along the dashed line 6J as shown in FIG. 6I where only one of the slots 606A′″ of the plurality of slots 606A′″ is shown. In the embodiment of FIGS. 61 and 6J, there is no solid aluminum metal 612′″ on the exterior surface of the TiB₂ substrate 602′″. The solid aluminum metal 612′″ completely fills the slot volume of the slot 606A′″.

FIG. 6K is a front view of an embodiment of a TiB₂ substrate 602″″ having a plurality of slots 606A, 606B, and 606B (collectively, slots 606″″) as directing features and a solid aluminum metal 612″″ covering some or none of the slots 606. FIG. 6L is a first side view of the embodiment shown in FIG. 6K. FIG. 6K shows the TiB₂ substrate 602″″ with a base 608″″ and a tip 610′″. The slots 606″″ have varying lengths, thicknesses, and amounts of the solid aluminum metal 612″″.

For slot 606A, the slot length does not extend to the tip 610″″ of the TiB₂ substrate 602′″. The top portion of the slot 606A does not contain the solid aluminum metal 612″″. The bottom portion of the slot 606A contains the solid aluminum metal 612″″. For slot 606B, the slot length extends from the top of the base 608″″ to the tip 610″″. The slot 606B does not contain the solid aluminum metal 612″″. Slot 606C does not start from the same place as slots 606A and 606B. The beginning of slot 606C starts further up the TiB₂ substrate 602″″. Slot 606C has solid aluminum metal 612″″ at the bottom and top, but not in the middle of the slot 606C.

FIG. 6M is a front view of an embodiment of a TiB₂ substrate 602′″″ with a surface area 620′″″ having a first portion 622′″″ of the surface area 620′″″ with a plurality of slots 606′″″ as directing features and a second portion 624′″″ of the surface area 620′″″ being absent of any directing feature. Prongs 604′″″ define the plurality of slots 606′″″. FIG. 6N is a first side view of the embodiment shown in FIG. 6M with the second portion 624″″″ of the surface area 620′″″ being absent of any directing feature.

The TiB₂ substrate 602′″″ includes a surface area 620′″″, wherein a first portion 622′″″ of the surface area 620′″″ includes the at least one directing feature, and wherein a second portion 624′″″ of the surface area 620′″″ is absent of any directing feature.

In some embodiments, the first portion 622′″″ of the surface area 620′″″ is at least partially covered by solid aluminum metal. In some embodiments, the first portion 622′″″ of the surface area 620′″″ is at least 1% covered by solid aluminum metal. In some embodiments, the first portion 622′″″ of the surface area 620′″″ is at least 5% covered by solid aluminum metal. In some embodiments, the first portion 622′″″ of the surface area 620′″″ is at least 10% covered by solid aluminum metal. In some embodiments, the first portion 622′″ of the surface area 620′″″ is at least 15% covered by solid aluminum metal. In some embodiments, the first portion 622′″″ of the surface area 620′″″ is at least 20% covered by solid aluminum metal. In some embodiments, the first portion 622′″″ of the surface area 620′″″ is at least 25% covered by solid aluminum metal. In some embodiments, the first portion 622′″″ of the surface area 620′″″ is at least 30% covered by solid aluminum metal. In some embodiments, the first portion 622′″″ of the surface area 620′″″ is at least 35% covered by solid aluminum metal. In some embodiments, the first portion 622′″″ of the surface area 620′″″ is at least 40% covered by solid aluminum metal. In some embodiments, the first portion 622′″″ of the surface area 620′″″ is at least 45% covered by solid aluminum metal. In some embodiments, the first portion 622′″″ of the surface area 620′″″ is at least 50% covered by solid aluminum metal. In some embodiments, the first portion 622′″″ of the surface area 620′″″ is at least 55% covered by solid aluminum metal. In some embodiments, the first portion 622′″″ of the surface area 620′″″ is at least 60% covered by solid aluminum metal. In some embodiments, the first portion 622′″″ of the surface area 620′″″ is at least 65% covered by solid aluminum metal. In some embodiments, the first portion 622″″″ of the surface area 620′″″ is at least 70% covered by solid aluminum metal. In some embodiments, the first portion 622′″″ of the surface area 620′″″ is at least 75% covered by solid aluminum metal. In some embodiments, the first portion 622′″″ of the surface area 620′″″ is at least 80% covered by solid aluminum metal. In some embodiments, the first portion 622′″″ of the surface area 620′″″ is at least 85% covered by solid aluminum metal. In some embodiments, the first portion 622′″″ of the surface area 620′″″ is at least 90% covered by solid aluminum metal. In some embodiments, the first portion 622′″″ of the surface area 620′″″ is at least 95% covered by solid aluminum metal. In some embodiments, the first portion 622′″″ of the surface area 620′″″ is at least 100% covered by solid aluminum metal.

In some embodiments, the second portion 624′″″ of the surface area 620′″″ is at least partially covered by solid aluminum metal. In some embodiments, the second portion 624′″″ of the surface area 620′″″ is at least 1% covered by solid aluminum metal. In some embodiments, the second portion 624′″″ of the surface area 620′″″ is at least 5% covered by solid aluminum metal. In some embodiments, the second portion 624′″″ of the surface area 620′″″ is at least 10% covered by solid aluminum metal. In some embodiments, the second portion 624′″″ of the surface area 620′″″ is at least 15% covered by solid aluminum metal. In some embodiments, the second portion 624′″″ of the surface area 620′″″ is at least 20% covered by solid aluminum metal. In some embodiments, the second portion 624′″″ of the surface area 620′″″ is at least 25% covered by solid aluminum metal. In some embodiments, the second portion 624′″″ of the surface area 620′″″ is at least 30% covered by solid aluminum metal. In some embodiments, the second portion 624′″″ of the surface area 620′″″ is at least 35% covered by solid aluminum metal. In some embodiments, the second portion 624′″″ of the surface area 620′″″ is at least 40% covered by solid aluminum metal. In some embodiments, the second portion 624′″″ of the surface area 620′″″ is at least 45% covered by solid aluminum metal. In some embodiments, the second portion 624′″″ of the surface area 620′″″ is at least 50% covered by solid aluminum metal. In some embodiments, the second portion 624′″″ of the surface area 620′″″ is at least 55% covered by solid aluminum metal. In some embodiments, the second portion 624′″″ of the surface area 620′″″ is at least 60% covered by solid aluminum metal. In some embodiments, the second portion 624′″″ of the surface area 620′″″ is at least 65% covered by solid aluminum metal. In some embodiments, the second portion 624′″″ of the surface area 620′″″ is at least 70% covered by solid aluminum metal. In some embodiments, the second portion 624′″″ of the surface area 620′″″ is at least 75% covered by solid aluminum metal. In some embodiments, the second portion 624′″″ of the surface area 620′″″ is at least 80% covered by solid aluminum metal. In some embodiments, the second portion 624′″″ of the surface area 620′″″ is at least 85% covered by solid aluminum metal. In some embodiments, the second portion 624′″″ of the surface area 620′″″ is at least 90% covered by solid aluminum metal. In some embodiments, the second portion 624′″″ of the surface area 620′″″ is at least 95% covered by solid aluminum metal. In some embodiments, the second portion 624′″″ of the surface area 620′″″ is at least 100% covered by solid aluminum metal.

In some embodiments, the solid aluminum metal covering the first portion 622′″″ and/or the second portion 624′″″ of the surface area 620′″″ is in the form of a film. In some embodiments, the film includes a thickness of from 1 μm to 500 μm. In some embodiments, the first portion 622′″″ and/or the second portion 624′″″ of the surface area 620′″″ is absent of the solid aluminum metal.

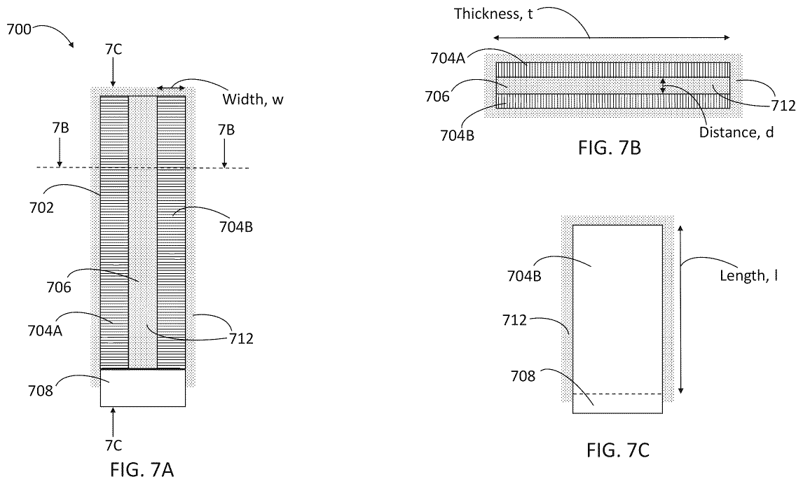

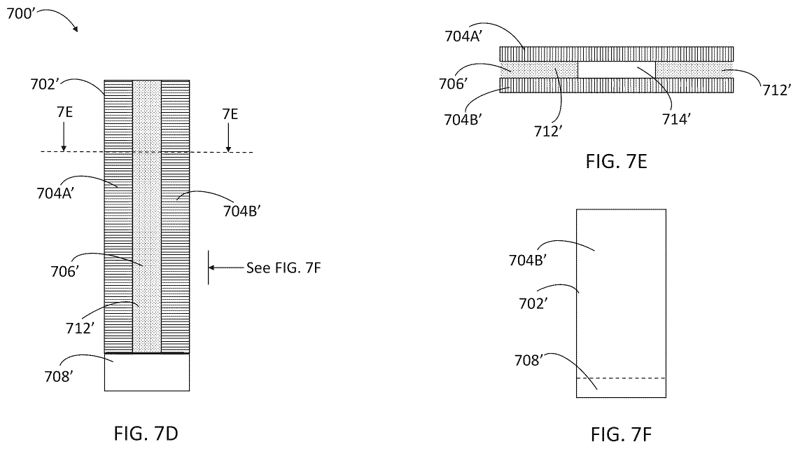

FIG. 7A is a front view of an embodiment of a product 700 with a TiB₂ substrate 702 having a slot 706 as a directing feature and a solid aluminum metal 712 covering the TiB₂ substrate 702. A portion of the solid aluminum metal 712 is shown around or transparent in FIG. 7A to reveal the surface structure of the substrate 702. A first prong 704A and a second prong 704B define the slot 706 extending upward from the base 708. FIG. 7B is a cross-section taken along the dashed line 7B shown in FIG. 7A. FIG. 7C is a first side view of a cross-section taken along the 7C shown in FIG. 7A.

FIG. 7D is a front view of an embodiment of a product 700′ of a TiB₂ substrate 702′ having a slot 706′ as a directing feature and a solid aluminum metal 712′ covering a portion of the slot 706′. A first prong 704A′ and a second prong 704B′ extend upwards from a base 708′, thereby defining the slot 706′. FIG. 7E is a cross-section taken along the dashed line 7E shown in FIG. 7D. As shown in FIG. 7E, a middle portion 714′ of the slot 706′ is absent the solid aluminum metal 712′. A front portion and a back portion of the slot 706′ are shown as having the solid aluminum metal 712′. FIG. 7F is a first side view of the embodiment shown in FIG. 7D.

The embodiment shown in FIGS. 7D, 7E, and 7F and the embodiment shown in FIGS. 7A, 7B, and 7C are the same or similar except for differences discussed herein. For example, the amount of solid aluminum metal 712/712′ covering the TiB₂ substrate 702/702′ differs between the embodiments. For the embodiment of FIGS. 7A, 7B, and 7C, the solid aluminum metal 712 covers almost the entirety of the TiB₂ substrate 702. Only a portion of the base 708 is covered with solid aluminum metal 712. The slot 706 is fully contained with solid aluminum metal 712. In contrast, the embodiment of FIGS. 7D, 7E, and 7F have no solid aluminum metal 712′ on the exterior of the TiB₂ substrate 702′. Only a portion of the slot 706′ is filled with solid aluminum metal 712′.

The embodiments of FIGS. 7A, 7B, 7C, 7D, 7E, and 7F are the same or similar as the embodiment of FIGS. 3A, 3B, and 3C. One difference is that FIGS. 3A, 3B, and 3C are not shown with solid aluminum metal on the TiB₂ substrate surfaces or covering at least portions thereof. The description of the solid aluminum metal from the embodiments of FIGS. 6A-6N also applies to the solid aluminum metal of FIGS. 7A-7F.

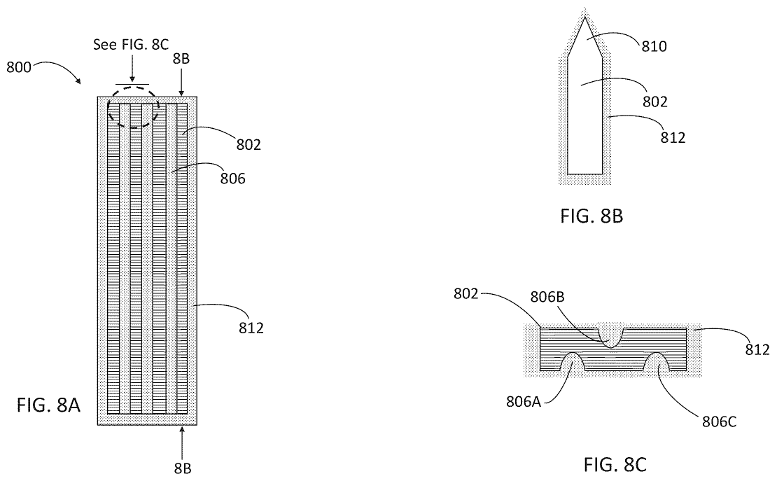

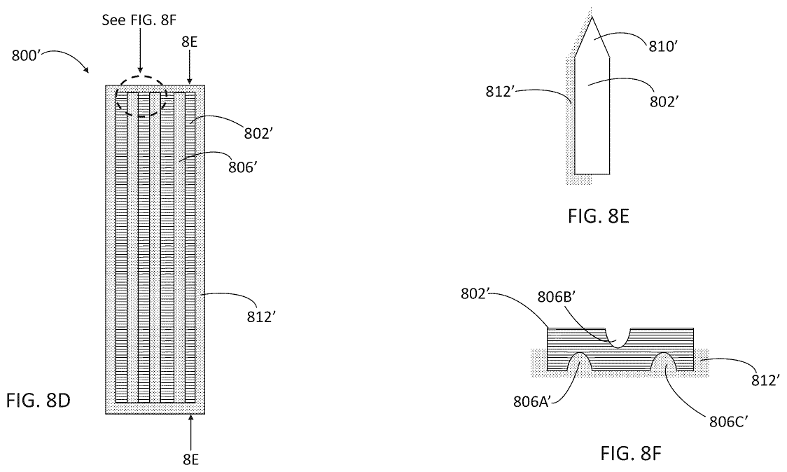

FIG. 8A is a front view of an embodiment of a product 800 with a TiB₂ substrate 802 having a plurality of grooves 806 as directing features and a solid aluminum metal 812 covering the TiB₂ substrate 802. A portion of the solid aluminum metal 812 is shown around or transparent in FIG. 8A to reveal the surface structure of the substrate 802. FIG. 8B is a first side view of a cross-section taken along line 8B shown in FIG. 8A. FIG. 8C is an enlarged partial section view of the embodiment shown in FIG. 8A as indicated by the dashed lines in FIG. 8A. FIG. 8C includes a view of a first groove 806A, a second groove 806B, and a third groove 806C.

FIG. 8D is a rear view of an embodiment of a product 800′ of a TiB₂ substrate 802′ having a plurality of grooves 806′ as directing features and a solid aluminum metal 812′ covering the front half of the TiB₂ substrate 802′. FIG. 8E is a first side view of a cross-section taken along the line 8E shown in FIG. 8D. FIG. 8F is an enlarged partial section view of the embodiment shown in FIG. 8D indicated by the circle of dashed lines in FIG. 8F.

The embodiment shown in FIGS. 8D, 8E, and 8F and the embodiment shown in FIGS. 8A, 8B, and 8C are the same or similar except for differences discussed herein. For example, the amount of solid aluminum metal 812/812′ covering the TiB₂ substrate 802/802′ differs between the embodiments. For the embodiment of FIGS. 8A, 8B, and 8C, the solid aluminum metal 812 is completely covering the TiB₂ substrate 802. In contrast, the solid aluminum metal 812′ in FIGS. 8D, 8E, and 8F only covers the front half of the TiB₂ substrate 802′.

The embodiments of FIGS. 8A, 8B, 8C, 8D, 8E, and 8F are the same or similar as the embodiment of FIGS. 4A, 4B, 4C and 4D. One difference is that FIGS. 4A, 4B, 4C, and 4D are not shown with solid aluminum metal on the TiB₂ substrate. FIGS. 8A, 8B, 8C, 8D, 8E, and 8F are shown with solid aluminum metal 812/812′ on the TiB₂ substrate. The description of the solid aluminum metal 612/712 from the embodiments of FIGS. 6A-6N and 7A-7F also applies to the solid aluminum metal 812/812′ of FIGS. 8A-8F.

For FIGS. 8A-8F, the at least one directing feature is a groove 806/806′, and the solid aluminum metal 812/812′ is at least partially contained within the groove 806/806′. The at least one groove 806/806′ includes a groove volume. In some embodiments, the solid aluminum metal 812/812′ occupies at least 1% of the groove volume. In some embodiments, the solid aluminum metal 812/812′ occupies at least 5% of the groove volume. In some embodiments, the solid aluminum metal 812/812′ occupies at least 10% of the groove volume. In some embodiments, the solid aluminum metal 812/812′ occupies at least 15% of the groove volume. In some embodiments, the solid aluminum metal 812/812′ occupies at least 20% of the groove volume. In some embodiments, the solid aluminum metal 812/812′ occupies at least 25% of the groove volume. In some embodiments, the solid aluminum metal 812/812′ occupies at least 30% of the groove volume. In some embodiments, the solid aluminum metal 812/812′ occupies at least 35% of the groove volume. In some embodiments, the solid aluminum metal 812/812′ occupies at least 40% of the groove volume. In some embodiments, the solid aluminum metal 812/812′ occupies at least 45% of the groove volume. In some embodiments, the solid aluminum metal 812/812′ occupies at least 50% of the groove volume. In some embodiments, the solid aluminum metal 812/812′ occupies at least 55% of the groove volume. In some embodiments, the solid aluminum metal 812/812′ occupies at least 60% of the groove volume. In some embodiments, the solid aluminum metal 812/812′ occupies at least 65% of the groove volume. In some embodiments, the solid aluminum metal 812/812′ occupies at least 70% of the groove volume. In some embodiments, the solid aluminum metal 812/812′ occupies at least 75% of the groove volume. In some embodiments, the solid aluminum metal 812/812′ occupies at least 80% of the groove volume. In some embodiments, the solid aluminum metal 812/812′ occupies at least 85% of the groove volume. In some embodiments, the solid aluminum metal 812/812′ occupies at least 90% of the groove volume. In some embodiments, the solid aluminum metal 812/812′ occupies at least 95% of the groove volume. In some embodiments, the solid aluminum metal 812/812′ occupies at least 100% of the groove volume.

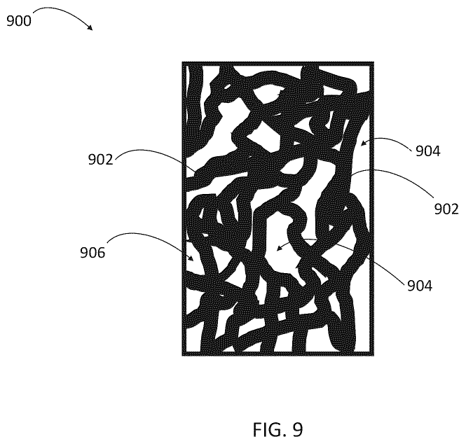

FIG. 9 is a close-up view of a portion of an embodiment of a product 900 of a TiB₂ substrate 902 with pores 904 and solid aluminum metal 906, in accordance with some embodiments. In some embodiments, the TiB₂ substrate 902 is a web, e.g., a sponge-like structure, of TiB₂.

In some embodiments, the product 900 includes a TiB₂ substrate 902 of a web of TiB₂ and solid aluminum metal 906 at least partially covering surfaces of the web of TiB₂ substrate 902. The web of the TiB₂ substrate 902 defines pores 904 within the web of TiB₂.

In some embodiments, the solid aluminum metal 906 has a porosity. The solid aluminum metal 906 may be at an elevated temperature when the solid aluminum metal 906 is filled in the pores 904. When the solid aluminum metal 906 cools, there may be space (e.g., pores or voids) between the solid aluminum metal 906 and the pores of the TiB₂ substrate 902. The pores 904 have a porosity of the TiB₂ substrate 902 web defining a porous volume of the TiB₂ substrate 902. In some embodiments the solid aluminum metal 906 occupies at least 1% of the porous volume. In some embodiments the solid aluminum metal 906 occupies at least 5% of the porous volume. In some embodiments the solid aluminum metal 906 occupies at least 10% of the porous volume. In some embodiments the solid aluminum metal 906 occupies at least 15% of the porous volume. In some embodiments the solid aluminum metal 906 occupies at least 20% of the porous volume. In some embodiments the solid aluminum metal 906 occupies at least 25% of the porous volume. In some embodiments the solid aluminum metal 906 occupies at least 30% of the porous volume. In some embodiments the solid aluminum metal 906 occupies at least 35% of the porous volume. In some embodiments the solid aluminum metal 906 occupies at least 40% of the porous volume. In some embodiments the solid aluminum metal 906 occupies at least 45% of the porous volume. In some embodiments the solid aluminum metal 906 occupies at least 50% of the porous volume. In some embodiments the solid aluminum metal 906 occupies at least 55% of the porous volume. In some embodiments the solid aluminum metal 906 occupies at least 60% of the porous volume. In some embodiments the solid aluminum metal 906 occupies at least 65% of the porous volume. In some embodiments the solid aluminum metal 906 occupies at least 70% of the porous volume. In some embodiments the solid aluminum metal 906 occupies at least 75% of the porous volume. In some embodiments the solid aluminum metal 906 occupies at least 80% of the porous volume. In some embodiments the solid aluminum metal 906 occupies at least 85% of the porous volume. In some embodiments the solid aluminum metal 906 occupies at least 90% of the porous volume.

The porosity of the TiB₂ substrate 902 can have any suitable porous structure. The porosity of the TiB₂ substrate 902 can be an interconnected porous structure, wherein at least some of the pores are in fluid communication with one another and facilitate movement of the wettable material from a first location to a second location (e.g., from a first predetermined location to a second predetermined location). Accordingly, the interconnected porous structure may be considered an open pore structure. In some embodiments, the porosity of the TiB₂ substrate 902 has a random porous structure. In some embodiments, the porosity of the TiB₂ substrate 902 can be an oriented porous structure. In some embodiments, the porosity of the oriented porous structure of the TiB₂ substrate 902 can be a porosity gradient. In some embodiments, the porosity gradient of the oriented porous structure of the TiB₂ substrate 902 can change along a three-dimensional gradient (i.e., the porosity gradient can change along the X-axis, Y-axis, and Z-axis of the TiB₂ substrate 902). In some embodiments, the porosity gradient of the oriented porous structure of the TiB₂ substrate 902 increases or decreases toward the center of the TiB₂ substrate 902. In some embodiments, the porosity gradient of the oriented porous structure of the TiB₂ substrate 902 can increase and/or decrease through the TiB₂ substrate 902. For instance, the porosity gradient of the oriented porous structure of the TiB₂ substrate 902 can increase, decrease, and then increase from one end of the TiB₂ substrate 902 to another end of the TiB₂ substrate 902.

An aluminum purification cell or an aluminum electrolysis cell can include any of the TiB₂ substrates described herein. In some embodiments, at least one of the TiB₂ substrates is an electrode for the aluminum purification cell or the aluminum electrolysis cell. In some embodiments, at least one of the TiB₂ substrates is a directing apparatus, where the directing apparatus is configured to direct liquid aluminum metal in a predetermined direction in an absence of an applied electrical current.

A product can include a TiB₂ substrate, as described herein, with at least one directing feature and solid aluminum metal at least partially covering surfaces of the TiB₂ substrate. The solid aluminum metal can be at least partially contained within the at least one directing feature. In some embodiments, at least one directing feature incudes a void volume. In some embodiments, at least 1% of the void volume contains the solid aluminum metal. In some embodiments, at least 5% of the void volume contains the solid aluminum metal. In some embodiments, at least 10% of the void volume contains the solid aluminum metal. In some embodiments, at least 15% of the void volume contains the solid aluminum metal. In some embodiments, at least 20% of the void volume contains the solid aluminum metal. In some embodiments, at least 25% of the void volume contains the solid aluminum metal. In some embodiments, at least 30% of the void volume contains the solid aluminum metal. In some embodiments, at least 35% of the void volume contains the solid aluminum metal. In some embodiments, at least 40% of the void volume contains the solid aluminum metal. In some embodiments, at least 45% of the void volume contains the solid aluminum metal. In some embodiments, at least 50% of the void volume contains the solid aluminum metal. In some embodiments, at least 55% of the void volume contains the solid aluminum metal. In some embodiments, at least 60% of the void volume contains the solid aluminum metal. In some embodiments, at least 65% of the void volume contains the solid aluminum metal. In some embodiments, at least 70% of the void volume contains the solid aluminum metal. In some embodiments, at least 75% of the void volume contains the solid aluminum metal. In some embodiments, at least 80% of the void volume contains the solid aluminum metal. In some embodiments, at least 85% of the void volume contains the solid aluminum metal. In some embodiments, at least 90% of the void volume contains the solid aluminum metal. In some embodiments, at least 95% of the void volume contains the solid aluminum metal. In some embodiments, at least 100% of the void volume contains the solid aluminum metal.

### EXAMPLES

### Example 1—Lab-Scale Testing

Manufacture of Porous TiB₂ Substrates (TiB₂ Foams)

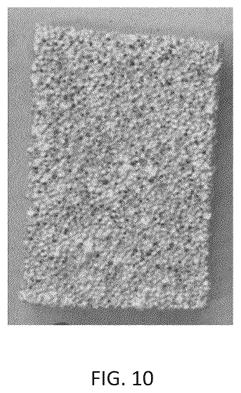

Four different TiB₂ foam samples, each of dimension of about 3-inch (H) by 2-inch (W) by 0.5 inch (D), were manufactured to have a porosity of about 10, 20, 30 and 45 PPI, respectively. The TiB₂ foam samples were manufactured by immersing polyurethane foams of different pore sizes in an aqueous slurry that had TiB₂ particles therein. The TiB₂ coated foams were then rolled between a set of parallel rollers with a defined gap thickness, which compressed the infiltrated foam and expelled unwanted slurry. The rolled TiB₂ foams were then hung in a drying oven. In some cases, the process was repeated, wherein the coated foams were re-immersed in the aqueous slurry and then air dried. The final dried TiB₂ foams were then sintered by heating at temperature of about 1850° C. FIG. 10 shows an example of a sintered end product. The sintered end products had continuous inter-connected pores with pore sizes of about 10, 20, 30, and 45 PPI corresponding to the respective polyurethane foam pore sizes. As shown in FIG. 10, the pore structure is an open pore structure allowing fluids to travel from one predetermined location to another predetermined location.

### Water Wetting Test

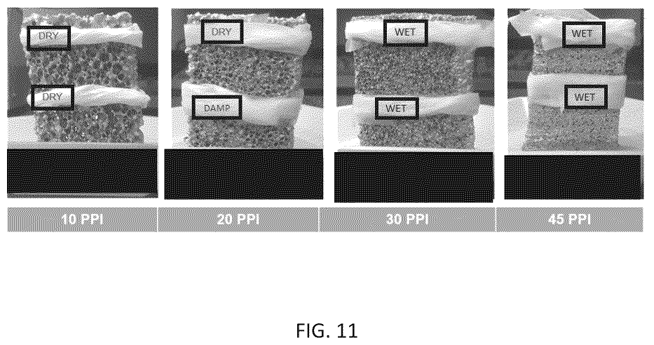

As shown in FIG. 11, each of the four TiB₂ foam samples (of about 10, 20, 30, and 45 PPI) was wrapped in two pieces of tissue paper, one piece of tissue paper at the top of the sample and one piece of tissue paper at the middle of the sample. The bottoms of the TiB₂ samples were then placed in 0.25 inch of water, well below the middle part of the samples, to test the samples' abilities to promote water mass transfer through capillary action. After about 12 hours of time, the samples were evaluated. None of the tissues in the about 10 PPI sample were damp or wet, indicating that no capillary action had occurred. In the about 20 PPI sample, the middle tissue was damp and the top issue was dry, indicating that some capillary action had occurred. In both the about 30 and 45 PPI samples, the middle and top tissues were wet, indicating that substantial capillary action had occurred.

Infiltration of TiB₂ Foams with Aluminum Metal

The sintered TiB₂ foams were submerged in molten aluminum for 1 minute then air quenched. After cooling completely, each of the four TiB₂ foam samples was then placed into about 0.5 inches deep slots of graphite carriers of three different crucibles (Crucible #1, Crucible #2, and Crucible #3, as further described below). Each of the three crucibles was installed in a furnace and heated in argon to 900° C. A purified molten aluminum composition (pure aluminum pellets) and a molten bath composition was added to each crucible. The molten bath composition was cryolite based and included NaF, AlF₃, and CaF₂ constituents.

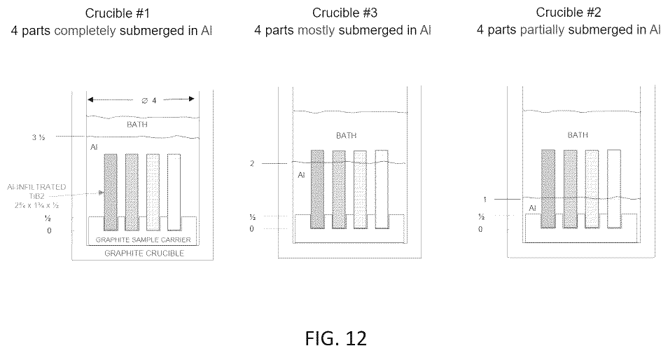

The crucibles having the four TiB₂ foam samples, molten aluminum, and cryolite, were held at 900° C. for about 48 hours. As shown in FIG. 12, in Crucible #1, the four TiB₂ foam samples were completely submerged in the molten aluminum for the 48 hours. In Crucibles #2 and #3, the four TiB₂ foam samples were partially submerged in approximately 1 and 2 inches of molten aluminum, respectively, with the remainder of the foams being exposed to the molten bath, for the 48 hours.

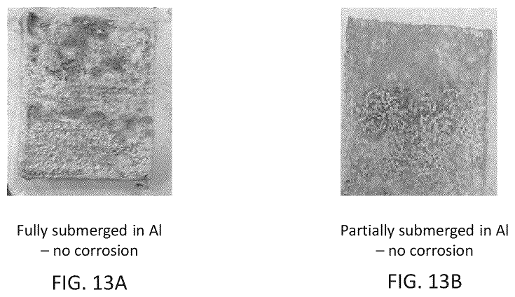

After 48 hours of testing at 900° C., as shown in FIG. 13A and FIG. 13B, no corrosion was observed for the four TiB₂ foam samples in any of the crucibles, indicating that the samples had been wetted by molten aluminum via capillary action facilitated by the pores of the foams. The molten aluminum protects TiB₂ from being corroded by cryolite.

### Example 2—Larger Lab-Scale Testing

### Manufacture of TiB₂ Foam Samples

Two different TiB₂ foam samples, each of dimension of about 16-inch (H) by 2-inch (W) by 0.5 inch (D), were manufactured by the process for the foam samples from Example 1. The sintered end product of the two TiB₂ foam samples had continuous inter-connected pores with pore sizes of about 20 and 30 PPI corresponding to the respective polyurethane foam pore sizes.

Infiltration of TiB₂ Foams with Aluminum Metal

Two untreated TiB₂ foam samples were placed into about 2-inches deep slots of a graphite carrier of a crucible. Prior to being placed in the graphite carrier, a purified molten aluminum composition (pure aluminum pellets) and a molten bath composition (cryolite based and included NaF, AlF₃, and CaF₂ constituents) was added to each crucible, then each crucible was then installed in a furnace and heated in argon to 900° C. After heating, each of the two TiB₂ foam samples was then placed in a crucible. Each crucible, having a TiB₂ foam sample, molten aluminum and cryolite, was then held at 900° C. After about 10 minutes of testing, the two TiB₂ foam samples were then pulled from the crucibles and molten aluminum was detected at the top of the samples. Similar to Example 1, no corrosion was observed for either of the two TiB₂ foam samples, indicating that the samples had been wetted by molten aluminum about 14 inches via capillary action facilitated by the pores of the foams. The molten aluminum protects TiB₂ from being corroded by cryolite.

While a number of embodiments of the present disclosure have been described, it is understood that these embodiments are illustrative only, and not restrictive, and that many modifications may become apparent to those of ordinary skill in the art. The various steps may be carried out in any desired order (and any desired steps may be added and/or any desired steps may be eliminated). For example, the features and characteristics of the directing features (e.g., slots, pores, or grooves) can be used together or alone with any of the products and/or TiB₂ substrates. The features and characteristics of the solid aluminum metal as described in any of the embodiments can be used in any other embodiment described herein. The exemplary embodiments of directing features and solid aluminum metal coverage are not meant to be exhaustive. The features and characteristics of the present disclosure can be combined in any manner.

What is claimed is:

1. A product comprising:
a ceramic substrate comprising a directing feature,
wherein the directing feature is configured to direct ceramic wettable material in a predetermined direction.

2. The product of claim 1, wherein the ceramic wettable material comprises aluminum.

3. The product of claim 2, wherein the aluminum is selected from the group consisting of an aluminum alloy, metallic aluminum, and combinations thereof.

4. The product of claim 1, wherein the directing feature is selected from the group consisting of a slot, a groove, pores, a channel, and combinations thereof.

5. The product of claim 1, wherein the directing feature is configured to direct the ceramic wettable material via capillary action.

6. The product of claim 1, wherein the directing feature comprises pores.

7. The product of claim 6, wherein the pores comprises a porosity of the ceramic substrate.

8. The product of claim 7, wherein the porosity ranges from about 1 to about 200 pores per inch (PPI).

9. The product of claim 1, wherein the directing feature comprises at least one slot, wherein the at least one slot extends through a thickness of the ceramic substrate.

10. The product of claim 1, wherein the ceramic substrate comprises a first prong and a second prong, and wherein the directing feature comprises a slot defined by an inner surface of the first prong and an inner surface of the second prong.

11. The product of claim 1, wherein the directing feature comprises at least one groove, wherein the at least one groove extends partially into the ceramic substrate.

12. The product of claim 1, wherein the ceramic substrate is a solid geometric form, and wherein the solid geometric form is at least one of rectangle-shaped, square-shaped, triangle-shaped, oval-shaped, or oblong-shaped.

13. A product comprising:
(a) a ceramic substrate comprising at least one directing feature; and
(b) solid aluminum metal at least partially covering surfaces of the ceramic substrate.

14. The product of claim 13, wherein the solid aluminum metal is at least partially contained within the at least one directing feature.

15. The product of claim 13, wherein the ceramic substrate comprises a surface area, wherein a first portion of the surface area comprises the at least one directing feature, and wherein a second portion of the surface area is absent of any directing feature.

16. The product of claim 15, wherein the first portion of the surface area is at least partially covered by the solid aluminum metal.

17. The product of claim 16, wherein the solid aluminum metal covering the second portion of the surface area is in a form of a film.

18. The product of claim 17, wherein the second portion of the surface area is absent of the solid aluminum metal.

19. A method comprising:
preparing a ceramic precursor product, wherein the ceramic precursor product comprises a directing feature; and
exposing the ceramic precursor product to elevated temperature thereby producing a final ceramic product having the directing feature therein, wherein the directing feature is configured to direct a ceramic wettable material in a predetermined direction.

20. The method of claim 19, wherein the final ceramic product is an electrode suited for use in an aluminum purification cell.
